(19) United States
(12) Patent Application Publication
(10) Pub. No.: US 2015/0331828 A1
(43) Pub. Date: Nov. 19, 2015

(54) COMPUTER-IMPLEMENTED GATEWAY

(71) Applicant: Amadeus S.A.S., Sophia Antipolis (FR)

(72) Inventors: Wim Maes, Berchem (BE); Frederik Colardyn, Booischot (BE); Soroush Karimi Rad, Wilrijk (BE); Ben Torfs, Antibes (FR); Jurgen Van Bouchaute, Lochristi (BE)

(73) Assignee: AMADEUS S.A.S., Sophia Antipolis (FR)

(21) Appl. No.: 14/278,388

(22) Filed: May 15, 2014

(51) Int. Cl. G06F 13/42; G06F 13/40

(52) U.S. Cl. CPC G06F 13/4208; G06F 13/4027

(57) ABSTRACT

Methods, systems, and computer program products for configuring an enterprise service bus. Based on user configuration settings, a configuration instance may be generated for the enterprise service bus. The configuration instance is communicated to the enterprise service bus. During run-time, the configuration instance may be configured to control an execution data flow for business data, such as travel data, through the enterprise service bus. Alternatively, a configuration instance at the enterprise service bus may be received by the enterprise service bus during run-time. The configuration instance is based on user configuration settings. The enterprise service bus may be configured to control an execution data flow for business data, such as travel data, through the enterprise service bus based on the configuration instance.

### BACKGROUND

The invention generally relates to computers and computer software and, in particular, to methods, systems, and computer program products for a computer-implemented gateway.

Middleware services may include hardware and/or software suitably configured to facilitate communications and/or process transactions between disparate computing systems. Middleware may be configured to process transactions between the various components of an application server and any number of internal or external systems for any of the purposes disclosed herein. An enterprise service bus is a software architecture that allows for the performance of complex tasks by a distributed set of middleware services in which each service performs a particular component function. An enterprise service bus may be used to design and implement the interaction and communication between mutually-interacting software applications in a service-oriented architecture.

Improved methods, systems, and computer program products are needed for a computer-implemented gateway.

### SUMMARY

Embodiments of the invention are directed to methods, systems, and computer program products for configuring an enterprise service bus.

In one embodiment, a configuration instance for the enterprise service bus is generated based on user configuration settings. The configuration instance is configured to control, during run-time, an execution data flow for business data, such as travel data, through the enterprise service bus.

In another embodiment, a configuration instance at the enterprise service bus is received by the enterprise service bus during run-time. The configuration instance is based on user configuration settings. The enterprise service bus is configured to control an execution data flow for business data, such as travel data, through the enterprise service bus based on the configuration instance

### BRIEF DESCRIPTION OF THE SEVERAL VIEWS OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a diagrammatic view of an exemplary operating environment including multiple computer systems.

FIG. 2 is a diagrammatic view of an exemplary computer system of FIG. 1.

FIG. 3 shows a schematic overview of a computer-implemented gateway in accordance with an embodiment of the invention.

FIG. 4 shows a schematic overview of a computer-implemented gateway in accordance with another embodiment of the invention.

### DETAILED DESCRIPTION

Generally, embodiments of the invention are directed to a gateway with an architecture for an enterprise service bus that can be altered during gateway runtime. The gateway may include an enterprise service bus and a central configuration system operatively coupled to the enterprise service. The central configuration system may be configured to receive user configuration settings and to generate, based on the user configuration settings, a configuration instance of the enterprise service bus during gateway run-time. By generating the configuration instance, a completely new architecture can be set up for the enterprise service bus or an existing architecture for the enterprise service bus can be re-configured by maintaining part of the existing architecture. Based on the user configuration settings that are received by the central configuration systems, the central configuration system may allow the architecture for the enterprise service bus to be at least partially configured and/or re-configured during gateway run-time by generating the configuration instance. The execution data flow may be amended or modified by amending or modifying the data processing components that are used in the execution data flow and/or by changing the inlet and/or by changing the outlet endpoint, etc. Therefore, the architecture of the enterprise service bus may be altered during runtime.

In an embodiment, the enterprise service bus includes an endpoint data processing component, a communication channel directly or indirectly coupled with either the input or output endpoint, and another communication channel directly or indirectly coupled with a core component. Such endpoint data processing components allow the enterprise service bus to communicate business data with and between the endpoints. By providing separate endpoint data processing components that communicate with the enterprise service bus, data processing components that process the business data before and after the endpoint data processing components are able to process the data with more independence of the way the business data was obtained from the endpoints. As a result, the data processing components may be generally employable in various different enterprise service buses and, thus, provide a higher degree of flexibility for generating the configuration instance of the enterprise service bus.

According to an embodiment, the data processing components at the endpoints may be adapted to the specific endpoints. Because the nature of the endpoints may determine the way in which the business data is communicated, the business data can be more easily communicated with the endpoints using specific data processing components at the endpoints. For example, the endpoints data processing components may be connected to enterprise servers.

According to an embodiment, the user configuration settings may include endpoint configuration settings that define at least one endpoint data processing component of the configuration instance for the enterprise service bus. Such endpoint configuration settings allow the user to configure the endpoint configuration settings of the configuration instance, for example, during gateway run-time.

According to an embodiment, the enterprise service bus may include an input endpoint data processing component configured to retrieve business data from the input endpoint, a communication channel that is directly or indirectly connected to the input endpoint, and another communication channel that is directly or indirectly connected to the core component. The data processing component may be configured to receive business data from the input endpoint via the associated communication channel, to generate modified business data, and to transmit the modified business data via the other communication channel to the core component. The modified business data that is generated may depend on the endpoint. For example, a portion of the business data specifically associated with the type of endpoint (e.g., information relating to the network server software or information relating to the protocol used by the endpoint) may be removed when generating the modified business data.

According to an embodiment, the enterprise service bus may include an output endpoint data processing component configured to output the business data to the output endpoint, a communication channel that is directly or indirectly connected to the core component, and another communication channel that is directly or indirectly connected to the output endpoint. The data processing component may be configured to receive business data from the core component via the associated communication channel, to generate modified business data, and to transmit the modified business data via the other communication channel to the output endpoint. The modified business data that is generated may depend on the endpoint. For example, a portion of the business data specifically associated with the type of endpoint (e.g., information relating to the network server software or information relating to the protocol used by the endpoint) may be added when generating the modified business data.

According to an embodiment, the central configuration system may include endpoint configuration information that allows an endpoint data processing component to communicate with the endpoint to which the endpoint data processing component is connected. Such endpoint information may include address information (e.g., IP address of the endpoint), port of the endpoint, login information of the endpoint (e.g., information relating to login name and/or password), mail address, file system information, subfolder, etc.

According to an embodiment, the user configuration settings may include the endpoint configuration information that defines the endpoint configuration information of the configuration instance for the enterprise service bus. The endpoint configuration information allows the user to configure the endpoint configuration information of the configuration instance, for example, during gateway run-time. Moreover, by separating the endpoint configuration information from the at least one endpoint data processing component and, preferably, the endpoint configuration settings, the endpoint data processing components of the configuration instance may be configured independently from the endpoint configuration information. As a result, the endpoint configuration information may be more abstractly defined to allow for a more flexible generation of the configuration instance.

According to an embodiment, the enterprise service bus may receive first business data from the core component via a communication channel connected to the core component, and may include at least one core data processing component configured to alter the business data into the modified business data, and to transmit the modified business data via another communication channel connected to the core component back to the core component. By providing at least one core data processing component specifically dealing with altering the arriving business data, a further abstraction can be made from the endpoint data processing components (which process the business data after and before the at least one core data processing component) such that the data can be more independently processed from the way the business data was obtained from the endpoints. As a result, the core data processing components may be more generally employable in different enterprise service buses and, thus, provide a higher degree of flexibility for generating the configuration instance.

According to an embodiment, the central configuration system may include a core data processing template that defines a sequence of at least two core data processing components. Such a core data processing template may permit frequently used sequences of at least two core data processing components or substantial parts of the data execution flow to be reused. The enterprise service bus may comprise at least two core data processing components.

According to an embodiment, the user configuration settings may include a core data processing component configuration defining a sequence of at least one core data processing component. Such core data component configuration allows the user to configure the core data processing component configuration information, and thus a substantial part of the data execution flow, of the configuration instance, for example during gateway run-time.

According to an embodiment, the core data processing component configuration may include the core data processing template further easing the ability of the user to configure a configuration instance.

According to an embodiment, the endpoint configuration settings, the endpoint configuration information, and the core data processing component configuration of the user configuration settings may be stored in separate files of the central configuration system and may collectively define the execution data flow from the input endpoint to the output endpoint. When distributing the information needed to generate the desired configuration instance over separate files, the information may be input in a parallel way by different people, which may allow people to concentrate on different aspects of the configuration instance and which may result in time savings. Moreover, the endpoint configuration settings, the endpoint configuration information, and/or the core data processing component configuration can be re-used in multiple enterprise service buses running on the enterprise service bus architecture. For example, the reuse may be applicable to two enterprise service buses having identical endpoint configuration settings and core data processing component configuration, but having different endpoint configuration information. As another example, the reuse may be applicable to two enterprise service buses having identical core data processing component configuration, but having different endpoint configuration information and endpoint configuration settings.

According to an embodiment, the execution data flow may further provide an error handling flow to the core for handling error data received from the data processing components.

According to an embodiment, the enterprise service bus may include at least one error core data processing component, and the error handling flow may define the at least one error core data processing component for sending error message notifications to the endpoints of the enterprise service bus. For example, the user configuration settings may define where the error message notification is sent to, in what format, etc.

According to an embodiment, the configuration system may be further communicatively coupled to the gateway such that, during configuration, the data processing components are configured inside the gateway. This feature may permit the addition of components to the configuration instance of the enterprise service bus at run-time of the gateway.

According to an embodiment, the input endpoint may be an enterprise resource planning server or a billing and settlement plan server used by travel agencies and transport companies (e.g., airlines) for accommodating the flow of data with respect to payments and travel between them, etc.

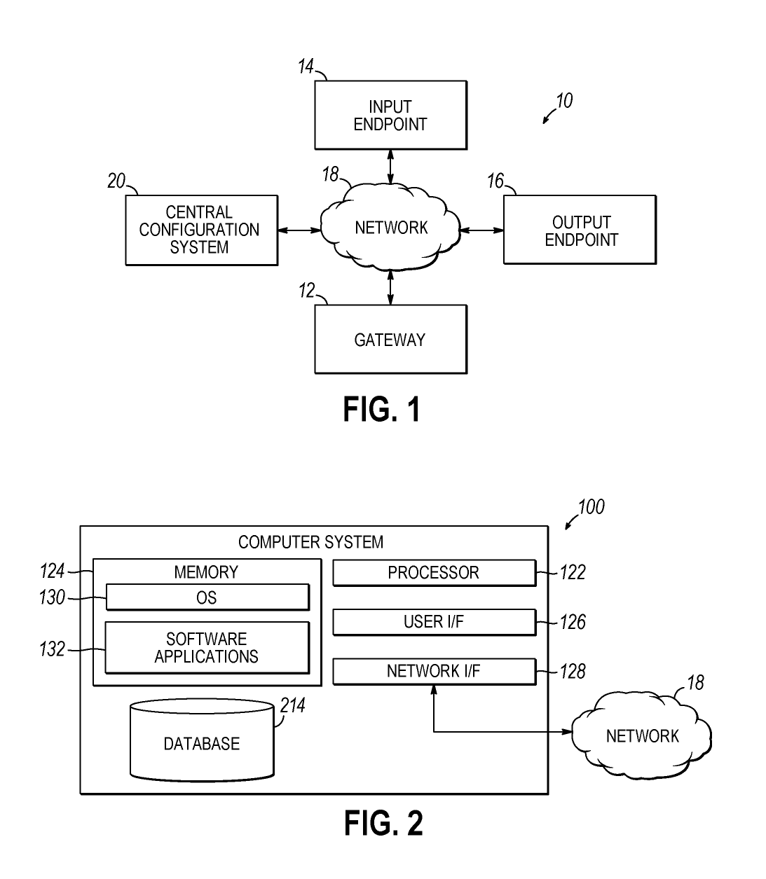

With reference to FIG. 1, an operating environment 10 may include a gateway 12 that is interconnected with an input endpoint 14 and an output endpoint 16 over a network 18 and a central configuration system 20 that is likewise connected with the network 18 and communicatively coupled with the gateway 12. The network 18 may include one or more private and/or public networks (e.g., the Internet) that enable the exchange of business data, such as travel data. Business data may be communicated over the network 18 from the input endpoint 14 through the gateway 12 to the output endpoint 16. Generally, the gateway 12 is a point of network interconnection at which information transfer occurs. In alternative embodiments and depending on the desired configuration, the gateway 12 may interconnect multiple input endpoints to a single output endpoint, a single input endpoint to multiple output endpoints, or the input endpoint and the output endpoint may be identical.

The gateway 12 may be implemented in a reconfigurable computer, and the endpoints 14, 16 may comprise one or more computer servers. For example, the endpoints 14, 16 may be enterprise servers providing middleware services, such as a HTTP/HTTPS server, a mail server (e.g., a POP3 or SMTP server), an FTP/SFTP server, a Java Message Service (JMS) listener, etc. The output endpoint 16 may be a back-office server. The gateway 12 and the endpoints 14, 16 may each comprise several interconnected computers, such as multiple computers interconnected through the network 18.

The configuration system 20 may be a separate computer interconnected to the gateway 12, for example by the network 18. Alternatively, depending on the desired configuration, the configuration system 20 may be part of the gateway 12 or part of the computer comprising the endpoint 14, 16.

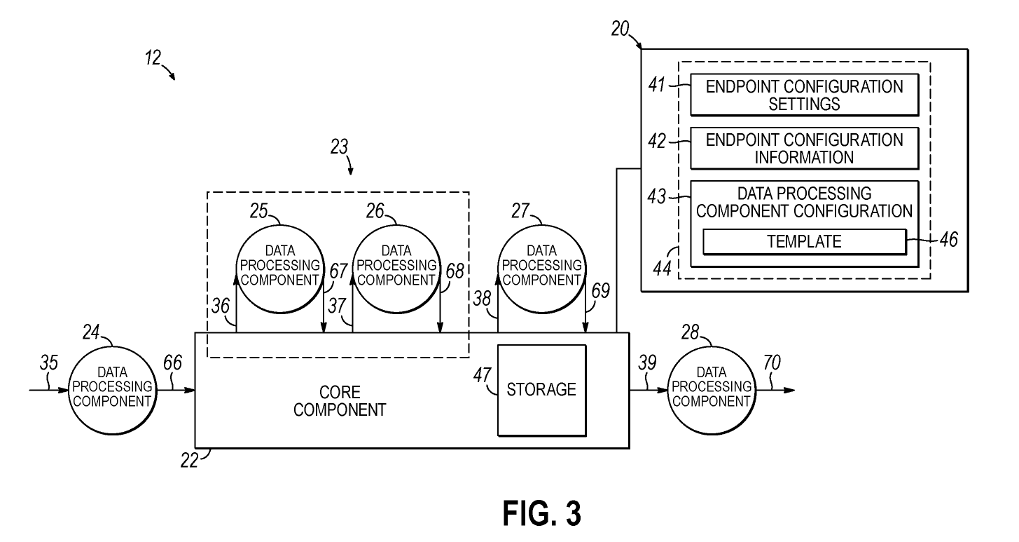

FIG. 2 provides a block diagram that illustrates an implementation of a core component 22 and data processing components 24, 25, 26, 27, 28 of an enterprise service bus 23 (FIG. 3) serving as the gateway 12 and/or the configuration system 20 on one or more computer devices or systems, such as a representative computer system 100. The computer system 100 includes at least one processor 122 that may be comprised of at least one hardware-based microprocessor and a memory 124 coupled to the at least one processor 122. The memory 124 may represent the random access memory (RAM) comprising the main storage of the gateway 12, as well as any supplemental levels of memory, e.g., cache memories, non-volatile or backup memories (e.g., programmable or flash memories), read-only memories, etc. In addition, memory 124 may be considered to include memory storage physically located elsewhere in the computer system 100, e.g., any cache memory in a microprocessor, as well as any storage capacity used as a virtual memory, e.g., as stored on a mass storage device or on another computer coupled to the computer system 100.

For interface with a user or operator, the computer system 100 may include a user interface 126 incorporating one or more user input/output devices, e.g., a keyboard, a pointing device, a display, a printer, etc. Otherwise, data may be communicated to and from another computer or terminal (e.g., the input endpoint 14, the output endpoint 16, and the configuration system 20) over a network interface 128 coupled to the communication network 18. The computer system 100 also may be in communication with one or more mass storage devices, which may be, for example, internal hard disk storage devices, external hard disk storage devices, external databases, storage area network devices, etc.

The computer system 100 typically operates under the control of an operating system 130 and executes or otherwise relies upon various computer software applications 132, which may comprise components, programs, objects, modules, engines, data structures, etc. In particular, each such computer software application 132 may comprise instructions that may be resident and/or stored in the memory 124.

The computer system 100 may include one or more databases 214. Each database 214 may comprise data and supporting data structures that store and organize data that is maintained and used by the computer system 100. In particular, the database 214 may be arranged with any database organization and/or structure including, but not limited to, a relational database, a hierarchical database, a network database, and/or combinations thereof. A database management system in the form of a computer software application executing as instructions on the processing unit of the computer system 100 may be used to access the information or data stored in records of the database 214 in response to a database query.

Moreover, various applications, components, programs, objects, modules, engines etc. may also execute on one or more processors in another computer coupled to the computer system 100 via the communication network 18, e.g., in a distributed or client-server computing environment, whereby the processing required to implement the functions of a computer program may be allocated to multiple computers over a network. For example, some of the functionality described herein as being incorporated into the computer system 100 and/or components of the computer system 100 may be implemented in one or more servers. Consistent with embodiments of the invention, the modules, applications, components and/or engines may be executing on one or more servers of the computer system 100, and may cause the processor 122 of the computer system 100 to perform operations consistent with embodiments of the invention.

With reference to FIG. 3, the architecture of the gateway 12 may include an enterprise service bus (ESB) 23 configured to perform data transformations. The enterprise service bus 23 may include a core component 22 and data processing components 24, 25, 26, 27, 28 each configured to receive arriving business data via respective communication channels 35, 36, 37, 38, 39. The data processing components 24-28 are further configured to generate modified business data from the arriving business data. The modified business data is then further transmitted from data processing components 24-28 via respective communication channels 66, 67, 68, 69, 70. The data processing component 24 is connected to the input endpoint 14 (FIG. 1) through communication channel 35 and the data processing component 28 is connected to the output endpoint 16 (FIG. 1) through communication channel 70.

The core component 22 of the enterprise service bus 23 is communicatively coupled via one or more of the communication channels 35-39 to each of the data processing components 24-28 for receiving business data. The core component 22 is configured to control a flow of business data through the respective data processing components 24-28 based on an execution data flow determined by a configuration instance for the enterprise service bus 23. The configuration instance represents an executable version of a program that is understandable by a computer's central processing unit and that is in an immediately executable condition when copied from storage into memory.

The core component 22 may include storage 47 that is configured to store the business data received from the endpoints 14, 16. The business data may be stored in the storage 47 before being forwarded to one of the core data processing components 25, 26, 27. The storage 47 may comprise the memory 124 (FIG. 2).

The input endpoint 14 is coupled by the communication channel 35 with data processing component 24. The input endpoint data processing component 24 is coupled by communication channel 35 with the core component 22. The output endpoint 16 is coupled by the communication channel 70 with output endpoint data processing component 28. The output endpoint data processing component 28 is coupled by communication channel 39 with the core component 22. The input endpoint data processing component 24 is configured to receive the business data arriving from the input endpoint 14 via the communication channel 35, generate the modified business data, and transmit the modified business data via the communication channel 36 to the core component 22. The output endpoint data processing component 28 is provided to receive the business data from the core component 22 via the communication channel 39, generate the modified business data, and transmit the modified business data via the communication channel 70 to the output endpoint 16.

The endpoint data processing components 24, 28 are adapted to the specific endpoints 14, 16. For example, the endpoint data processing components 24, 28 may be coupled to enterprise servers, for example middleware services like a HTTP/HTTPS server, a mail server, for example a POP3 or SMTP server, an FTP/SFTP server, a Java Message Service (JMS) listener, etc. and, as such, the endpoint data processing components 24, 28 are retrieve to retrieve the business data from the enterprise servers. For example, the data processing component 24 can be configured to retrieve mail from a mail server and to strip information from the business data that is irrelevant for the further treatment of the business data, such as specific mail-related information like information in the e-mail header. As another example, the data processing component 24 can be configured to retrieve a file from an FTP server upon addition of a file to the FTP server, to receive a request from an HTTP server, etc. As another example, the data processing component 28 can be configured to cause an e-mail server to send out the modified business information received via the communication channel 39 in an e-mail, for example, as an e-mail attachment. The data processing component 28 can be provided to provide the mail server with necessary data for sending out the e-mail, such as for example, e-mail address, etc. According to further examples, the data processing component 28 can be adapted to put a file on an FTP server, to send a message to an HTTP server, etc.

Each of the core data processing components 25, 26, 27 of the enterprise service bus 23 may be configured to receive business data from the core component 22 via any the communication channels 36, 37, 38 and then to modify or alter the received business data into altered business data. The altered business data may be transmitted from back to the core component 22 via one of the communication channels 37, 38, 39. In an alternative embodiment, only a data processing component may be present.

The flow of business data through the core data processing components 25, 26, 27 may be steered according to the execution data flow determined by the ESB configuration instance so that the business data retrieved at the input endpoint 14 can be processed before sending the business data to the output endpoint 16.

For example, the business data retrieved from the input endpoint 14 may be transmitted from the input endpoint data processing component 24 to the core component 22. The core component 22, based on the execution data flow determined by an ESB configuration instance, may forward the business data to the data processing component 25 via the communication channel 36. In response, the data processing component 25 may alter or process the arriving business data to generate modified business data and then transmit the modified business data via the communication channel 37 back to the core component 22. The core component 22 then, according to the execution data flow determined by the ESB configuration instance, may transmit the modified business data to the core data processing component 26 via the communication channel 37. In response, the core data processing component 26 may further alter or process the business data and then transmit the further modified business data via the communication channel 38 back to the core component 22. The core component 22 may, according to the execution data flow determined by the ESB configuration instance, transmit the business data received from the core data processing component 26 to the output endpoint data processing component 28 via the communication channel 39, which in response outputs the business data to the output endpoint 16. Alternatively, the core component 22 may, according to a different execution data flow determined by the ESB configuration instance, cause the core data processing component 26 to be bypassed so that the only data modification is provided by the core data processing component 25.

The core data processing components 25, 26, 27 can have a multitude of functionalities including, but not limited to, analyze the first business data, extract relevant data from the first business data, format business data, transform business data, etc.

In an alternative embodiment, multiple communication channels may couple one or more of the core data processing components 25, 26, 27 with the core component 22 to receive business data and/or multiple communication channels may couple one or more of the core data processing components 25, 26, 27 with the core component 22 to communicate business data back to the core component 22. For example, each of the core data processing components 25, 26, 27 may receive each of multiple batches of arriving business data through a different communication channel and, in response to the arrival of the multiple batches of business data, generate the modified business data. As another example, each of the core data processing components 25, 26, 27 may receive the business data through a single communication channel and, in response to the arrival of the business data, generate a multiple batches of processed business data each transmitted back to the core component 22 through its own communication channel. Moreover, a combination of these two possibilities may permit one or more of the core data processing components 25, 26, 27 to receive each of multiple batches of arriving business data through multiple communication channels and, in response to the arrival of the batches of business data, generate multiple batches of business data each of which is transmitted through a respective communication channel back to the core component.

In addition, the multiple communication channels may also be used to receive other information than business data. For example, a communication channel could be used by the corresponding data processing component to retrieve the business data through a communication channel and a configuration for the data processing component through a different communication channel. Accordingly, the data processing component may be configured depending on the input received through a communication channel and, for example, to provide several alternatives for configuring the data processing component.

A template 46 may be used to define a sequence of at least two core data processing components 25, 26, which may be used and re-used when generating ESB configuration instances. According to the execution data flow determined by a representative ESB configuration instance, using the template 46, the business data received by the input endpoint data processing component 24 may be routed, at least in part, by the core component 22 to the core data processing component 27 via the communication channel 38 and/or the output endpoint data processing component 28 via the communication channel 39. The sequence defines a predetermined order to the routing of data through the enterprise service bus 23. The template 46 comprises one or more files that can be used as a starting point for a particular sequence so that the entire sequence does not have to be recreated each time it is used.

With continued reference to FIG. 3, the central configuration system 20 may be configured to receive user configuration settings 44 and, based on at least the user configuration settings 44, to generate the ESB configuration instance during gateway run-time. As the configuration system 20 shown in FIG. 3 is further communicatively coupled to the gateway 12, during configuration, the data processing components 24-28 can be configured inside the computer implemented gateway 12, thereby enabling for ESB components to be added to the ESB configuration instance during run-time of the gateway 12. The user configuration settings 44 may comprise endpoint configuration settings 41 defining one or more of the endpoint data processing components 24, 28 of the ESB configuration instance, and endpoint configuration information 42 allowing each endpoint data processing component 24, 28 to communicate with the respective endpoint 14, 16 to which each of the endpoint data processing components 24, 28 is connected.

The endpoint configuration information 42 for example comprises at least one or more from the list of: address information, preferably IP address of the endpoint, port of the endpoint, login information of the endpoint, for example information relating to login name and/or password, mail address, file system information, subfolder, etc. For example, when the data processing component 28 coupled with the output endpoint 16 is provided to provide a mail server to send out an e-mail, the endpoint configuration information 42 may comprise information on the recipient's e-mail address, the IP address of the mail server, the desired content, such as for example body or title, of the e-mail, etc.

The core data processing component configuration 43 may comprise a core data processing template 46 defining a sequence of two or more data processing components, such as core data processing components 25, 26. The endpoint configuration settings 41, the endpoint configuration information 42 and the core data processing component configuration 43 of the user configuration settings 44 may be stored in separate files of the central configuration system 20 and collectively define the execution data flow from the input endpoint 14 to the output endpoint 16.

The user configuration settings 44 may be adapted by a user by amending the endpoint configuration settings 41, the endpoint configuration information 42, and/or the core data processing component configuration 43. In one embodiment, the files in which the user configuration settings 44 are stored may be amended. The central configuration system 20 may include an interface allowing the user to amend the endpoint configuration settings 41, the endpoint configuration information 42, and/or the core data processing component configuration 43. The interface may be a command-line interface onto which the user could log on, for example, remotely.

The core data processing component configuration 43 may be created in a graphical user interface (GUI) environment and then copied onto the central configuration system 20.

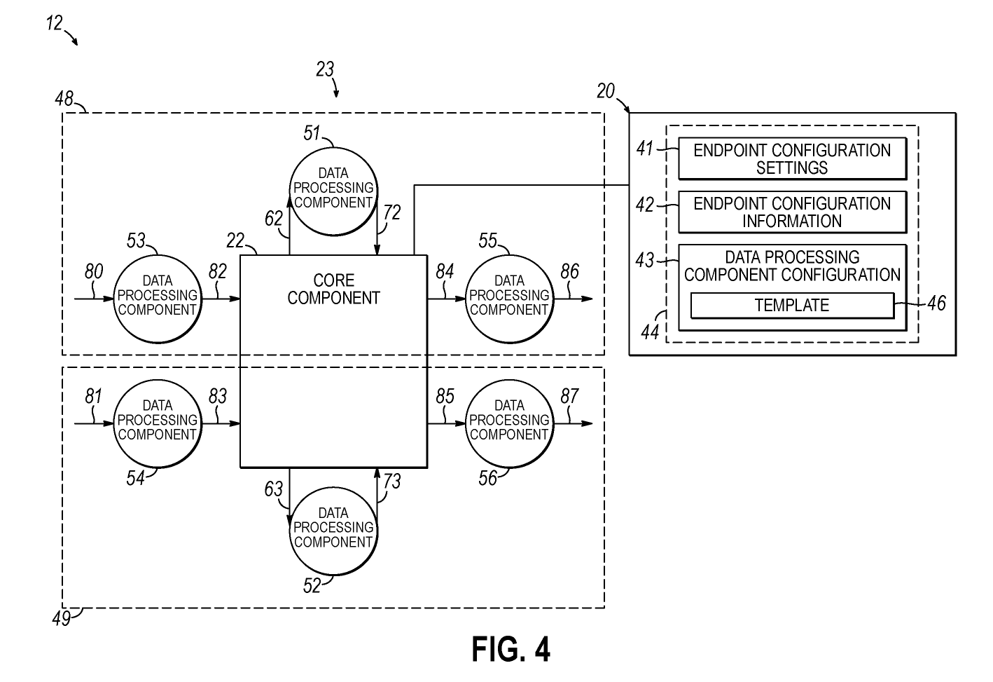

With reference to FIG. 4 and in accordance with an alternative embodiment, an ESB architecture includes core data processing components 51, 52 and endpoint data processing components 53, 54, 55, 56. Core data processing component 51 is coupled with the core component 22 via communication channels 62, 72. Core data processing component 52 is coupled with the core component 22 via communication channels 63, 73. Endpoint data processing components 53, 54 are input endpoint data processing components, and endpoint data processing components 55, 56 are output endpoint data processing components. The input endpoint data processing components 53, 54 are coupled with the core component 22 via respective communication channels 82, 83 and are coupled with different input endpoints 14 by respective communication channels 80, 81. The output endpoint data processing components 55, 56 are coupled with the core component 22 by respective communication channels 84, 85 and are connected to different output endpoints 16 by respective communication channels 86, 87. Further, the ESB configuration instance results in the configuration of multiple enterprise service buses 48, 49.

The enterprise service bus 48 includes the core data processing component 51 coupled with the core component 22, the input endpoint data processing component 53 and the output endpoint data processing component 55. The enterprise service bus 49 includes the core data processing component 52 coupled with the core component 22, the input endpoint data processing component 54, and the output endpoint data processing component 56. Either of the enterprise service buses 48, 49 may include any number of core data processing components and endpoint data processing components.

The ESB configuration instance may be determined by the central configuration system 20 through the endpoint configuration settings 41, the endpoint configuration information 42, and the core data processing component configuration 43 of the user configuration settings 44 are stored on the central configuration system 20. Generally, the user configuration settings 44 define the execution data flow from, in this embodiment, the input endpoints to the output endpoints.

The structure of the central configuration system 20 and, in particular, the user configuration settings 44 can be determined depending on a desired configuration. The user configuration settings can include one or more respective sets of endpoint configuration settings, the endpoint configuration information, and the core data processing component configuration with each set of endpoint configuration settings, the endpoint configuration information and the core data processing component configuration defining a different respective enterprise service bus. Each different set of endpoint configuration settings, endpoint configuration information, and core data processing component configuration may be stored in different files in the central configuration system 20.

Additional enterprise service buses may be added to the enterprise service buses 48, 49 of the ESB architecture by amending or modifying the user configuration settings 44 at the central configuration system 20. For example, the endpoint configuration settings 41 can be modified to add an input endpoint data processing component and an output endpoint data processing component. As another example, the core data processing component configuration 43 may be modified to add a sequence defining at least a portion of the execution data flow. As another example, the endpoint configuration information 42 may be modified. These modifications may be made by adding information to an existing set of user configuration settings or by creating a new set of user configuration settings.

The information present in the user configuration settings 44 defining an enterprise service bus may be divided among the endpoint configuration settings 41, the endpoint configuration information 42, and the core data processing component configuration 43. As a result, only part of this information can be re-used in configuring a different enterprise service bus. For example, only the endpoint configuration settings 41 and the core data processing component configuration 43 can be copied when setting up an enterprise service bus.

In general, the routines executed to implement the embodiments of the invention, whether implemented as part of an operating system or a specific application, component, program, object, module or sequence of instructions, or even a subset thereof, will be referred to herein as “computer program code,” or simply “program code”. Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution.

The program code embodied in any of the applications/modules described herein is capable of being individually or collectively distributed as a program product in a variety of different forms. In particular, the program code may be distributed using a computer readable media, which may include computer readable storage media and communication media. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

These computer program instructions may also be stored in a computer readable medium that can direct a computer, other types of programmable data processing apparatus, or other devices to function in a particular manner, such that the instructions stored in the computer readable medium produce an article of manufacture including instructions that implement the function/act specified in the block or blocks of the flowchart and/or block diagram.

The computer program instructions may also be loaded onto a computer, other programmable data processing apparatus, or another device to cause a series of computations to be performed on the computer, the other processing apparatus, or the other device to produce a computer implemented process such that the executed instructions provide one or more processes for implementing the functions/acts specified in the flowchart and/or block diagram block or blocks.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the present invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A method for configuring an enterprise service bus, the method comprising:
generating, based on user configuration settings, a configuration instance for the enterprise service bus that is configured to control, during run-time, an execution data flow for business data through the enterprise service bus.

2. The method of claim 1 wherein the configuration instance for the enterprise service bus is generated at a configuration system, and further comprising:
communicating the configuration instance from the configuration system to the enterprise service bus.

3. The method of claim 1 wherein the user configuration settings comprise endpoint configuration settings defining a first data processing component of the enterprise service bus to be coupled to an input endpoint or a second data processing component of the enterprise service bus to be coupled to an output endpoint.

4. The method of claim 1 wherein the user configuration settings comprise endpoint configuration information allowing a first data processing component of the enterprise service bus to communicate with an input endpoint or a second data processing component of the enterprise service bus to communicate with an output endpoint.

5. The method of claim 1 wherein the user configuration settings comprise a core processing component configuration for a plurality of core data processing components of the enterprise service bus.

6. The method of claim 1 wherein the user configuration settings comprise a sequence for processing the business data with a plurality of core data processing components.

7. The method of claim 1 wherein the user configuration settings comprise a template specifying a sequence for processing the business data with a plurality of core data processing components of the enterprise service bus.

8. The method of claim 1 wherein the user configuration settings comprise an error handling flow may define the at least one error core data processing component for sending error message notifications to endpoints of the enterprise service bus.

9. An apparatus for configuring an enterprise service bus, the apparatus comprising:
at least one processor; and
a memory coupled to the at least one processor and including instructions that, when executed by the at least one processor, cause the apparatus to:
generate, based on user configuration settings, a configuration instance for the enterprise service bus to control, during run-time, an execution data flow for business data through the enterprise service bus.

10. The apparatus of claim 9 wherein the user configuration settings comprise endpoint configuration settings defining a first data processing component of the enterprise service bus to be coupled to an input endpoint or a second data processing component of the enterprise service bus to be coupled to an output endpoint.

11. The apparatus of claim 9 wherein the user configuration settings comprise endpoint configuration information allowing a first data processing component of the enterprise service bus to communicate with an input endpoint or a second data processing component of the enterprise service bus to communicate with an output endpoint.

12. The apparatus of claim 9 wherein the user configuration settings comprise a core processing component configuration for a plurality of core data processing components of the enterprise service bus.

13. The apparatus of claim 9 wherein the user configuration settings comprise a sequence for processing the business data with a plurality of core data processing components.

14. The apparatus of claim 9 wherein the user configuration settings comprise a template specifying a sequence for processing the business data with a plurality of core data processing components of the enterprise service bus.

15. A computer program product for configuring an enterprise service bus, the computer program product comprising:
a non-transitory computer readable storage medium; and
instructions stored on the non-transitory computer readable storage medium that, when executed by a processor, cause the processor to:
generate, based on user configuration settings, a configuration instance for the enterprise service bus to control, during run-time, an execution data flow for business data through the enterprise service bus.

16. A method for configuring an enterprise service bus, the method comprising:
during run-time of the enterprise service bus, receiving a configuration instance at the enterprise service bus that is based on user configuration settings; and
configuring the enterprise service bus to control an execution data flow for business data through the enterprise service bus based on the configuration instance.

17. The method of claim 16 wherein the configuration instance is received at the enterprise service bus from a configuration system.

18. The method of claim 16 wherein the enterprise service bus includes a first data processing component specified by the configuration instance to receive the business data from an input endpoint and a second data processing component specified by the configuration instance to process the business data, and further comprising:
receiving the business data from the input endpoint at the first data processing component;
communicating the business data from the first data processing component to the second data processing component of the enterprise service bus; and
processing the business data with the second data processing component.

19. The method of claim 16 wherein the enterprise service bus includes a first data processing component specified by the configuration instance to process the business data and a second data processing component specified by the configuration instance to communicate the business data to an output endpoint process, and further comprising:
processing the business data with the first data processing component; and
after the business data is processed, communicating the business data from the first data processing component to the second data processing component for communication to an output endpoint.

20. The method of claim 16 wherein the configuration instance specifies one or more core processing components of the enterprise service bus that are configured to process the business data.

21. The method of claim 16 wherein the configuration instance specifies a plurality of core processing components of the enterprise service bus that are configured to process the business data, and the configuration instance specifies a sequence for processing the business data with the core data processing components.

22. The method of claim 17 wherein the configuration instance specifies an error handling flow for handling error data received from a core processing component of the enterprise service bus.

23. The method of claim 17 wherein the configuration instance specifies one or more data processing components to be added to the configuration instance during run-time.

24. The method of claim 17 wherein the configuration instance specifies endpoint configuration information that allows at least one data processing component of the enterprise service bus to communicate with an endpoint.
